(19) United States
(12) Patent Application Publication
(10) Pub. No.: US 2023/0232810 A1
(43) Pub. Date: Jul. 27, 2023

(54) EXTENDABLE AND ADJUSTABLE INSECT ENTRAPMENT APPARATUS

(71) Applicant: Esther Kim, San Gabriel, CA (US)

(72) Inventor: Esther Kim, San Gabriel, CA (US)

(21) Appl. No.: 18/093,745

(22) Filed: Jan. 5, 2023

Related U.S. Application Data
(63) Continuation of application No. 16/987,368, filed on Aug. 6, 2020, now abandoned.
Application No. 16/987,368 is a continuation of application No. 15/629,070, filed on Jun. 21, 2017, now abandoned.

(51) Int. Cl. A01M 1/14; A01M 3/04

(52) U.S. Cl. CPC A01M 1/14; A01M 3/04; A01M 2200/01

(57) ABSTRACT

An extendable and adjustable insect entrapment apparatus reaches insects and pests in hard to reach areas through a multi-jointed elongated rod that hinges and pivots into various configuration to reach and entrap the insects with a pad of stacked, singular sticky sheets. The rod has a proximal end with a formed hole for hanging the apparatus from a distal end. At least one joint in the rod is fixedly set at a desired angle and orientation. The sticky sheets retain any insects which travel or fall into a base at the distal end of the rod. Each sheet is coated with a mild compression adhesive material that entraps an insect in response to an application of force against the insect. Each sticky sheet can be separated individually. Upon entrapment of an insect, the outermost sticky sheet restraining the insect is separated, folded to encase the insect, and disposed of.

### CROSS-REFERENCE TO RELATED APPLICATIONS

The present application is a continuation of U.S. patent application Ser. No. 16/987,368, filed Aug. 6, 2020, which is a continuation of U.S. patent application Ser. No. 15/629,070, filed Jun. 21, 2017, now abandoned, the disclosures of which are incorporated in their entireties for all purposes.

### FIELD OF THE INVENTION

The present invention relates generally to an extendable and adjustable insect and pest entrapment apparatus. More so, an insect termination apparatus helps reach insects behind objects, in small corners, and in hard to reach spaces through a multi-jointed elongated rod that hinges and pivots into a plurality of configurations to reach insects and entrap the insects with a pad of stacked, singular sticky sheets to retain any insects which travel or fall into a base at the distal end of the rod; and whereby each sheet has a region coated with a mild compression adhesive material that is configured to entrap an insect in response to an application of force against the insect; whereby the pad of stacked adhesive sheets can be used by separating each sheet individually or as a stack; and whereby upon entrapment of an insect, the sheet restraining the insect is separated, if not already separated from the stack, folded to encase the insect, and disposed of

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, insect populations of various species are prevalent pests in every part of the world. The hardiness, small size, and large numbers associated with insects make them troublesome to deal with when an infestation or similar problem should arise. One common approach utilized in an attempt to control insect populations in homes and the like is that of placing insect traps.

Conventional stationary insect traps are known in the prior art. These conventional traps are placed where insects crawl or hide, such as the kitchen, bathroom, laundry, basement and garage. These insect traps are sized so at to allow placement along baseboards, under sinks, near refrigerators and stoves, in closet pantries, cabinets and behind toilets.

Often, the stationary insect traps have openings so as to allow insects to enter at either end of the trap. The conventional traps further provide a black hole and a natural food bait that lures insects out of hiding places and into the trap. Once inside, the insects get stuck in a powerful adhesive and die.

However, such insect traps are stationary and do not allow the insect trap to be quickly positioned from a distance in front of a running insect after it is sited. This ability to catch a running insect from a safe distance is particularly desirable for those who are frightened or disgusted by the sight of insects, particularly cockroaches.

Other proposals have involved trapping insects from a distal position. The problem with these insect traps is that they do not bend and rotate to reach behind objects and comers. Also, the ends are not sufficiently sticky to entrap the insect. Even though the above cited insect traps meet some of the needs of the market, a hose gripping apparatus that wraps around a pressurized hose and provides a handle, so as to enhance the grip on a pressurized hose by magnifying a grip pressure on the hose during operation, facilitating manipulation of the hose, and adjusting for various hose sizes and pressures is still desired.

### SUMMARY

Illustrative embodiments of the disclosure are generally directed to an extendable and adjustable insect entrapment apparatus that can be easily manipulated to reach and entrap insects behind objects, in small comers, and in hard to reach spaces.

In some embodiments, the apparatus is used to control insects and pests by facilitating access and entrapment thereof. The apparatus is configured to access insects in hard to reach areas through a multi-jointed elongated rod that hinges and pivots into various configuration to reach and entrap the insects with a pad of stacked, singular sticky sheets. The rod has a proximal end with a formed hole for hanging the apparatus and a distal end. At least one joint in the rod can be fixedly set at a desired angle and orientation.

In some embodiments, the sticky sheets retain insects that travel or fall into a base at the distal end of the rod. Each sheet is coated with a mild compression adhesive material that entraps an insect in response to an application of force against the insect. Each sticky sheet can be separated individually. Upon entrapment of an insect, the outermost sticky sheet restraining the insect is separated, folded to encase the insect, and disposed of.

In another aspect, the at least one joint is operable to rotate.

In another aspect, the handle has a textured surface.

In another aspect, the base has a generally rectangular shape.

In another aspect, the sheets further comprises an attractant for insects.

Another objective of the invention is to position the pad on the end of an elongate rod, thereby providing a means for extension of the apparatus's reach, greatly increasing the versatility of the apparatus in the pursuit and apprehension of the intended insect or pest.

Another objective of the invention is to provide a manually manipulated insect entrapment apparatus that employs pressure sensitive adhesive sheets for the capture of insects or other small pests.

Another objective of the invention is to provide an apparatus which has an adhesive coated sheet with restraining capability only after the adhesive portion of the sheet is pressed firmly against an intended insect, compressing and adhering the insect onto the adhesive.

Another objective of the invention is to provide a pad of disposable stacked adhesive sheets with releasable tabs allow easy sheet separation, as intended insects are captured and restrained, the outermost sheet is further used as a medium for wrapping the captured insect for proper disposal.

Another objective of the invention is to provide a hole in the proximal end of the rod 102 that enables the apparatus to by mounted or hung in a user's home, car, or other convenient location, enabling the apparatus to be readily accessible for those times when, unexpectedly, insects are discovered crawling on or around a person, their children, or pets.

Yet another objective of the invention to provide a manual insect entrapment apparatus that requires a minimum of skill and training to use and manipulate is inexpensive and effective.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary extendable and adjustable insect entrapment apparatus retaining an insect on a sticky sheet, in accordance with an embodiment of the present invention;

FIG. 2 illustrates a perspective view of an extendable and adjustable insect entrapment apparatus, showing a rod having at least one joint fully extended in a linear configuration, in accordance with an embodiment of the present invention;

FIG. 3 illustrates a perspective view of an extendable and adjustable insect entrapment apparatus, showing a second joint at the distal end of the rod hinged at an angle, in accordance with an embodiment of the present invention;

FIG. 4 illustrates a perspective view of an extendable and adjustable insect entrapment apparatus, showing a first and second joint angled to refill the pad from a sticky sheet container, in accordance with an embodiment of the present invention;

FIG. 5 illustrates a perspective view of an extendable and adjustable insect entrapment apparatus extended in a linear configuration to engage a ground surface, in accordance with an embodiment of the present invention;

FIG. 6 illustrates a perspective view of an exemplary reserve pad with new sticky sheets replacing a depleted pad in the base, in accordance with an embodiment of the present invention; and

FIG. 7 illustrates a perspective view of an exemplary telescoping rod having a pad release switch and two lock and release switches, in accordance with an embodiment of the present invention.

Like reference numerals refer to like parts throughout the various views of the drawings.

### DETAILED DESCRIPTION OF THE INVENTION

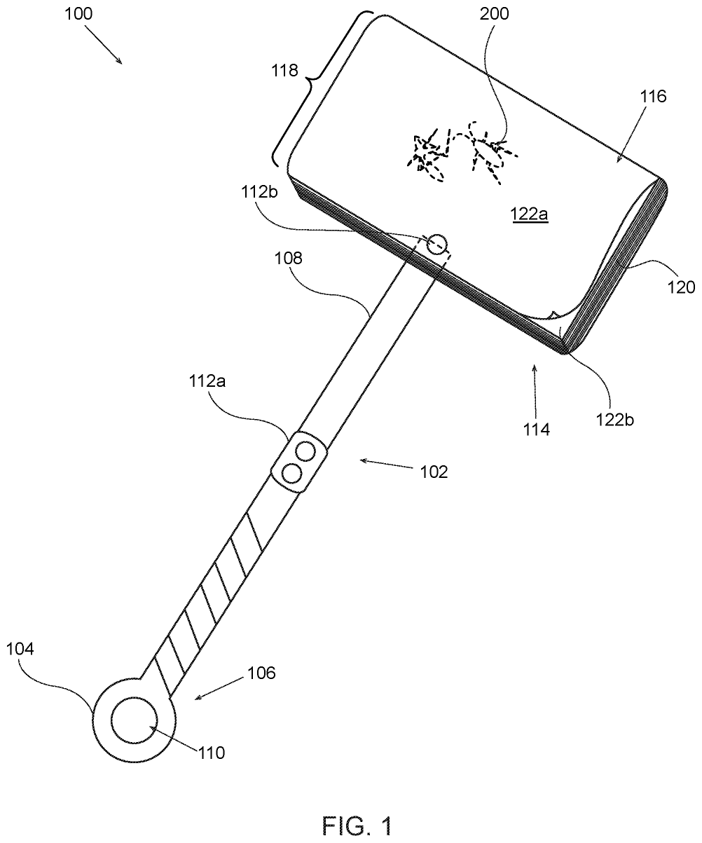

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. § 112.

In one embodiment of the present invention presented in FIGS. 1-5, an extendable and adjustable insect entrapment apparatus 100 works to entrap insects 200 and pests behind objects, in small comers, and in hard to reach spaces through use of an elongated rod 102 that manipulates in different configurations and terminates at a sheets of sticky pads to grip the insect. For example, the apparatus 100 reaches an insect 200 in hard to reach areas through use of a multi-jointed elongated rod 102 that hinges and pivots into a plurality of configuration to reach insects 200 in distal areas, and hard to reach comers.

As FIG. 1 references, the extendable and adjustable insect entrapment apparatus 100, hereafter “apparatus 100” provides an elongated, adjustable rod 102 that helps reach an insect 200 in distal and hard to reach places, such as in a corner or behind objects insects 200 hide like furniture. The rod 102 is configured so that a hand can easily transmit axial and lateral forces through the proximal end 104 of the rod 102 for entrapping the insect 200 at a distal end 108 of the rod 102.

A base 114 hingedly attaches to the distal end 108 of the rod 102. The base 114 supports a pad 120 of stacked, singular sticky sheets 122a, 122b that are configured to retain any insects 200 which travel or fall into contact with the outermost sticky sheet. The sticky sheet encases both a front region 116 and at least one peripheral region 118 of the base 114. The base 114 may have sharp corners, so as to fit into corners.

Each sheet 122a-b is coated with a mild compression adhesive material that is configured to entrap an insect 200 in response to an application of force against the insect 200. The pad 120 of stacked adhesive sheets 122a, 122b can be used by separating each sheet individually or as a stack. Thus, upon entrapment of an insect 200, the outermost sheet 122a that is restraining the insect 200 is separated, if not already separated from the stack 122b, folded to encase the insect 200, and disposed of

In some embodiments, the pad 120 of stacked adhesive sheets 122a, 122b can have various sheet sizes, thickness and density with varying enveloping ability. The pad 120 can also be slightly curved, or flat, depending upon the type and size of insect to be entrapped. In an alternative embodiment, the sticky sheet 122a-b is also coated with an attractant in a central zone so that insects 200 must traverse at the curved surface to reach the attractant. In one embodiment, the pad is a lint roller.

One aspect of an extendable and adjustable insect entrapment apparatus 100, the apparatus 100 comprising a multi-jointed elongated rod 102 configured to hinge and rotate about at least one joint 112a, 112b into a plurality of configuration, the rod 102 defined by a distal end 108 and a proximal end 104 forming a hole 110, whereby the at least one joint 112a, 112b is fastenable to retain a fixed configuration. The apparatus further comprises a handle 106 coupled to the proximal end 104. A base 114 hingedly attaches to the distal end 108 of the rod 102. The base 114 is defined by a front region 116 and a plurality of peripheral regions 118 that form at least one generally sharp corner.

The apparatus further comprises a pad 120 of stacked, singular sticky sheets 122a, 122b, the pad 120 configured to encase the front region 116, the plurality of peripheral regions 118, and the at least one generally sharp corner of the base 114, the sheets 122a, 122b being coated with a mild compression adhesive material configured to entrap an insect 200 in response to an application of force against the insect, pad 120 of stacked adhesive sheets 122a, 122b configured to enable separating each sheet individually.

In this manner, the configuration of the rod 102 and the generally sharp corner of the base 114 help reach the insect 200. The apparatus 100 enables manipulation of the proximal end 104 of the rod 102 to transmit the force to the sheet coated with a mild compression adhesive material. In another aspect, the at least one joint 112a, 112b comprises a hinge at a middle section of the rod 102, and a hinge at the intersection of the base 114 and the distal end 108 of the rod 102.

Those skilled in the art will recognize that common insects and other pests which are frequently encountered may include ticks, roaches, gnats, spiders, ants, flies, bees, wasps, scorpions, crickets, beetles, and grasshoppers. It may be desirable to catch and restrain such insects without having to physically touch or handle the insects directly. Direct contact with such insects and pests is undesirable because they may bite or sting.

Moreover, insects and pests may serve as carriers of disease or harmful germs. Brushing insects off or dropping the insect onto the floor is unsightly, does not restrain the insect and does not address the disposal problem. Swatting insects is often undesirable because the action frequently leaves a residue of the insect on the surface and also makes the disposal of the insect inconvenient.

Furthermore, it is widely recognized that in circumstances where in the insect or pest is not resting on a hard surface, swatting the insect may not be effective. Swatting an insect may also leave a residue, such as blood, from the insect on the flyswatter which is also undesirable. The use of insecticides is likewise disfavored because of the hazardous nature of the chemicals used and the possible adverse health and environmental effects associated with pesticides.

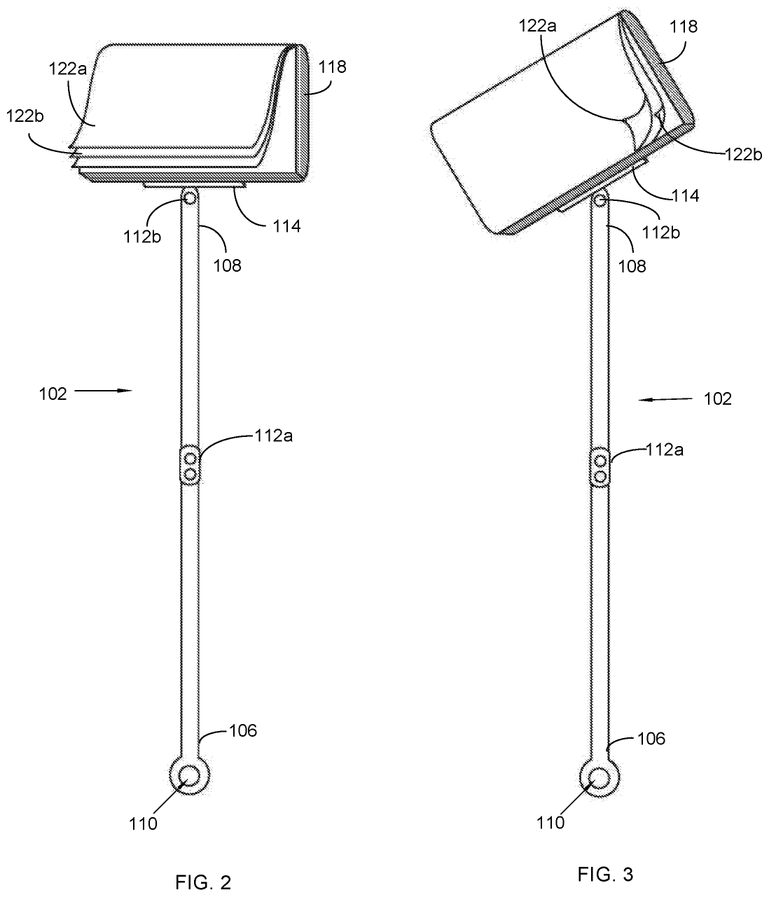

Thus, as FIG. 2 references, the present disclosure provides an extendable and adjustable insect entrapment apparatus 100 helps to reach insects in hard to reach areas through use of a rod 102 that hinges and pivots into a plurality of configuration to reach insects 200 in hard to reach or distal areas. The rod 102 is defined by a proximal end 104 forming a hole 110 and a distal end 108. A human can also transmit forces through a handle 106 on a proximal end 104 of the rod 102 for entrapping the insect at a distal end 108 of the rod 102.

A handle 106 having a textured surface may join the proximal end 104. The handle enhances the grip for operation of the apparatus 100. In one embodiment, the handle 106 may be a sleeve that forms a snug fit over the proximal end 104. A hole 110 forms in the proximal end 104 of the rod 102. The hole 110 allows the apparatus 100 to be hung or mounted in a user's home, car, or other convenient location, enabling the apparatus 100 to be readily accessible for those times when, unexpectedly, insects are discovered crawling on or around one's person, their children or pets.

Looking now at FIG. 3, the multi jointed elongated rod 102 is configured to hinge and rotate about at least one joint 112a, 112b into a plurality of configuration that may be useful for reaching insects in hard to reach places. In some embodiments, the at least one joint 200 can rotate. The joint 112a, 112b is fastenable to retain a fixed configuration. The joint 112a, 112b can be tightened through various fastening means known in the art to retain a desired configuration. In this manner, the joints enable the rod 102 to be configured into myriad different combinations of angles and orientations.

For example, FIG. 2 shows the rod 102 in a linear configuration, while 3 shows a second joint 112a, 112b in the rod 102 hinged at a slight angle to reach an insect in a comer. In another example, a first joint 112a, 112b midway along the rod 102 can be bent at a 45° angle, while a second joint 112a, 112b at the intersection of the distal end 108 of the rod 102 and the base 114 can be tightened so that the base 114 orients at a small slope.

In some embodiments, a knob attaches at the joint 112a-b to apply a friction fit force on the joint 112a, 112b, and thereby hold the joint 112a-b in a fixed position. The knob can be used to retain this configuration for the rod 102, and then release the friction fit force to change the configuration of the rod 102. Nonetheless, the angles of pivoting by joints 112a-b can be changed by releasing the fastening means and reconfiguring the joint 112a, 112bs to a desired configuration for the rod 102.

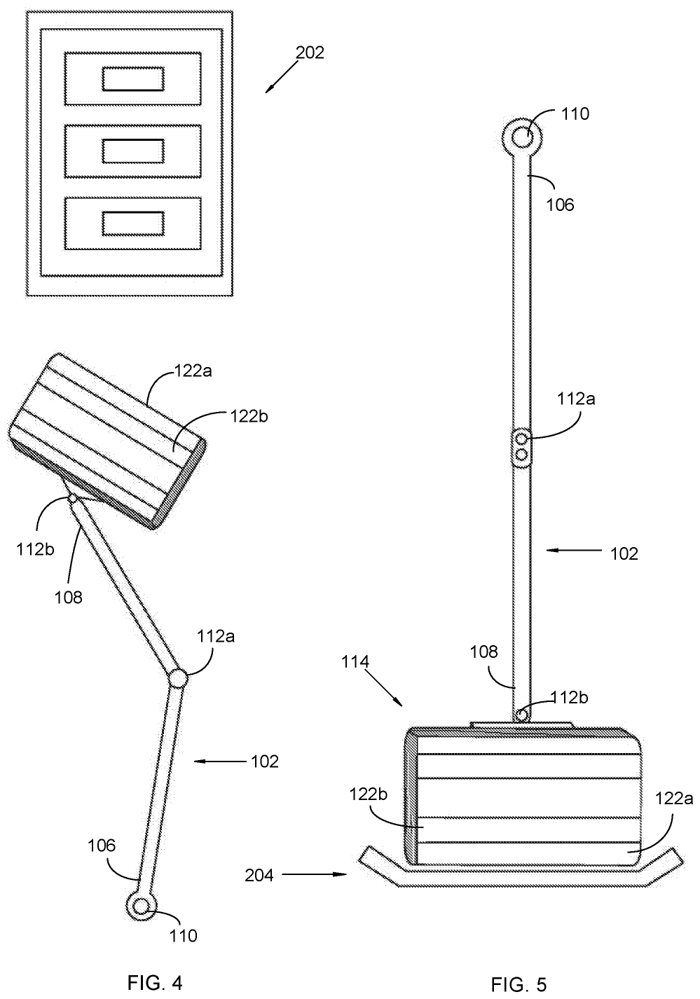

For example, FIG. 4 illustrates a perspective view of the apparatus 100, showing a first and second joint 112a, 112b angled at about 45° to refill the pad 120 from a sticky sheet container 202. The pad is simply engaged with a new stack of sticky sheets and attached thereto. However, this same angled configuration can also be used to reach an insect behind furniture, or other objects known to provide shelter for an insect.

In yet another possible configuration of the apparatus 100 shown in FIG. 5, the rod 102 is in a linear configuration to engage a ground surface 204. Thus, in the linear configuration in which the joints are fixedly extended linearly, a user can sweep the ground surface 204 of insects and even dirt simultaneously in this configuration. However, myriad combinations of rod angles and configurations may be achieved through fixed adjustment of the at least one hinge 112a-b.

A base 114 hingedly attaches to the distal end 108 of the rod 102. The base 114 hingedly attached at the distal end 108 of the rod 102. In one embodiment, the base 114 is defined by a front region 116 and a plurality of peripheral regions 118 that form at least one generally sharp comer. In one embodiment, the base 114 has a generally rectangular shape.

The base 114 is configured to support a pad 120 of stacked, singular sticky sheets 122a, 122b. The pad 120 is shaped similar to the base 114. In some embodiments, the pad 120 may be flat, or curved, rectangular, or square shaped. The stack of sticky sheets 122a, 122b are adapted to retain any insects which travel or fall into contact with the outermost sticky sheet.

In one embodiment, the sticky sheet are configured to encase both the front region 116 and peripheral regions 118 of the base 114. In this manner, the entirety of the base 114 is covered by sticky sheets 122a, 122b. And since the base 114 has sharp comers that are sized and angled to efficiently fit into comers, the sticky sheets 122a, 122b can engage the same areas.

Further, the rod 102, as described above, allows for various angles and orientations, which provide even greater access capabilities for the sticky sheets 122a, 122b.

Looking again at FIG. 1, each sheet may be coated with a mild compression adhesive material that is configured to entrap an insect 200 in response to an application of force against the insect. The pad 120 of stacked adhesive sheets 122a, 122b can be used by separating each sheet individually or as a stack. Thus, upon entrapment of an insect 200, the outermost sticky sheet that is restraining the insect is separated, if not already separated from the stack, folded to encase the insect, and disposed of.

In one possible embodiment, at least one releasable tab loosely hold the pad 120 of disposable stacked adhesive sheets 122a-b around the periphery of the base 114. The tabs allow for easy sheet separation, as the outermost sticky sheet 122a can be pulled out to overcome the frictional force of the tabs, while the remaining sticky sheets 122b remain on the pad 120. In this manner, as insects 200 are captured and restrained, the outermost sheet 122a is further used as a medium for wrapping the captured insect for proper disposal.

The pad 120 of stacked adhesive sheets 122a-b can have various sheet sizes, thickness and density with varying enveloping ability, depending upon the type and size of insect 200 to be entrapped. In one embodiment, the sticky sheet 122a-b is slightly larger than the base 114, so as to encase the base 114. In an alternative embodiment, the sticky sheet is coated with an attractant in a central zone so that insects must traverse at the curved surface to reach the attractant.

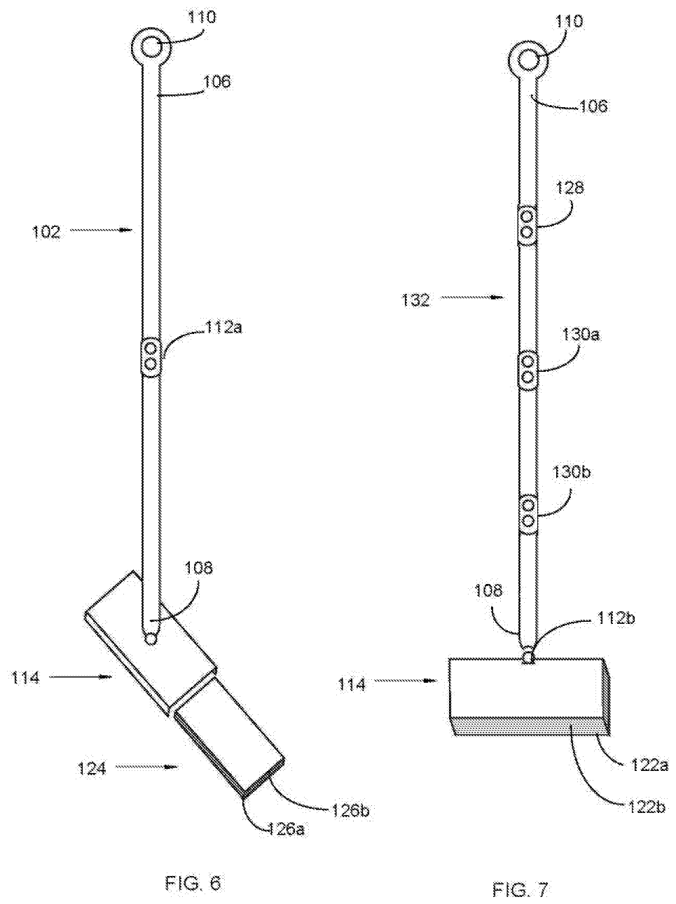

Turning now to FIG. 6, the apparatus 100 may utilize at least one reserve pad 124 of sticky sheets when the original pad 120 has depleted all of the sticky sheets 122a-b. This allows a user to have easy, quick access to a perpetual source of sticky sheets while reusing the rod 102. In operation, the base 114 supports a pad 120 of stacked, singular sticky sheets 122a-b that are configured to retain any insects 200. Once the sticky sheets 122a-b are depleted, the pad 120 slides laterally from the base 114, and the reserve pad 124, hosing a plurality of new sticky sheets 126a, 126b slides into the base for entrapping insects.

In one alternative embodiment, shown in FIG. 7, the rod 102 hosts various switches 128, 130a, 130b that provide additional functionality to the apparatus 100. In the example above, the reserve pad 124 replaces the original pad 120. This functionality is facilitated through use of a pad release switch 128 that operatively connects to the base 114. The pad release switch 128 is configured to enable quick, easy releasing and locking of the pads 120, 124 to the base 114.

Thus, when the pad 120 is depleted, the pad release switch 128 is manipulated, and the reserve pad 124 slides into the base. The pad release switch 128 may include, without limitation, a button, a tab, a switch, and a screw.

Furthermore, at least one extension and retraction switch 130a, 130b positions along the rod 102. The extension and retraction switch 130a-b is operational with a telescoping rod 132 that extends to become longer or retracts to become shorter. In one embodiment, the extension and retraction switch 130a-b utilizes a tab and lock mechanism to extend and release a spring loaded telescoping rod. However, in other embodiments, different rod-extending mechanisms known in the art may be used. In this manner, the user may selectively adjust the length of the apparatus to access insects that are on a ceiling, or farther away from the user.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

1. An extendable and adjustable insect entrapment apparatus, the apparatus comprising:
a multi jointed elongated rod configured to hinge and rotate about multiple joints into a plurality of configurations, the rod defined by a distal end and a proximal end,
at least one of the joints hingedly articulating,
at least one of the joints rotatably articulating,
at least one of the joints being fastenable to restrict hinged or rotatable articulation;
a handle coupled to the proximal end;
a base hingedly attached at the distal end of the rod, the base defined by a front region and a plurality of peripheral regions that form at least one sharp corner; and
a pad of stacked, singular sticky sheets, the pad configured to encase the front region, the plurality of peripheral regions, and the at least one sharp corner of the base, the sheets being coated with a mild compression adhesive material configured to entrap an insect in response to an application of force against the insect, the pad of stacked adhesive sheets configured to enable separating each sheet individually,
whereby the configuration of the rod and the sharp corner of the base help reach the insect,
whereby manipulation of the proximal end of the rod transmits the force to the sheet coated with a mild compression adhesive material.

2. The apparatus of claim 1, wherein the proximal end of the rod forms a hole.

3. The apparatus of claim 1, wherein the at least one joint comprises a hinge at a middle section of the rod.

4. The apparatus of claim 1, wherein the at least one joint comprises a hinge at the intersection of the base and the distal end of the rod.

5. The apparatus of claim 1, wherein the at least one joint is operable to axially rotate.

6. The apparatus of claim 1, wherein the handle has a textured surface.

7. The apparatus of claim 1, further comprising a pad release button operable to release the pad and enable mating of a reserve pad with new sticky sheets in the base.

8. The apparatus of claim 1, further comprising a telescoping rod operable to extend and retract with at least one extension and retraction switch.

9. The apparatus of claim 1, further comprising an attractant for insects, the attractant coating the sheets.

10. The apparatus of claim 1, wherein the sheets are slightly larger than the base.

11. The apparatus of claim 1, wherein the base is configured with sharp corners.

12. An extendable and adjustable insect entrapment apparatus, the apparatus consisting of:
a multi jointed elongated rod configured to hinge and rotate about multiple joints into a plurality of configurations, the rod defined by a distal end and a proximal end forming a hole,
at least one of the joints hingedly articulating,
at least one of the joints rotatably articulating,
at least one of the joints being fastenable to restrict hinged or rotatable articulation;
a handle coupled to the proximal end;
a base defined by a generally rectangular shape, the base hingedly attached at the distal end of the rod, the base defined by a front region and a plurality of peripheral regions that form at least one sharp corner;
a pad of stacked, singular sticky sheets, the pad configured to encase the front region, the plurality of peripheral regions, and the at least one sharp corner of the base, the sheets being coated with a mild compression adhesive material configured to entrap an insect in response to an application of force against the insect, pad of stacked adhesive sheets configured to enable separating each sheet individually,
whereby the configuration of the rod and the sharp corner of the base help reach the insect,
whereby manipulation of the proximal end of the rod transmits the force to the sheet coated with a mild compression adhesive material; and
an attractant for insects, the attractant coating the sheets.

13. The apparatus of claim 12, wherein the at least one joint comprises a hinge at a middle section of the rod.

14. The apparatus of claim 12, wherein the at least one joint comprises a hinge at the intersection of the base and the distal end of the rod.

15. The apparatus of claim 12, wherein the at least one joint is operable to axially rotate.

16. The apparatus of claim 12, wherein the handle has a textured surface.

17. The apparatus of claim 12, wherein the sheets are slightly larger than the base.

18. The apparatus of claim 12, wherein the base is configured with sharp corners.

19. The apparatus of claim 12, wherein the pad is a lint roller.

20. The apparatus of claim 12, wherein the pad has a generally rectangular shape.
